(19) United States
(12) Patent Application Publication
(10) Pub. No.: US 2026/0316490 A1
(43) Pub. Date: Oct. 15, 2026

(54) VEHICLE WHEEL WITH WHEEL FACE FOR GRAPHIC DESIGN ELEMENT

(71) Applicant: Re:Car Inc., Troy, MI (US)

(72) Inventors: Mayur Malaviya, Troy, MI (US); Pritish Panda, Troy, MI (US); Julien Fesquet, Beverly Hills, CA (US); Gustavo Bizyk, Los Angeles, CA (US); Tisha Johnson, Douglas, MI (US); Eric Amano, Lexington, KY (US); Jamie Standring, Beverly Hills, MI (US)

(21) Appl. No.: 19/644,502

(22) Filed: Apr. 10, 2026

Related U.S. Application Data
(60) Provisional application No. 63/786,776, filed on Apr. 10, 2025.

(51) Int. Cl. B60B 7/06; B60B 21/10

(52) U.S. Cl. CPC B60B 7/063; B60B 21/104

(57) ABSTRACT

A wheel for a vehicle having a disc secured to a disc support of the rim and providing a wheel face that is dimensioned and configured to support a graphic design element, the disc has a generally planar wall; a first inwardly angled wall extending inwardly from the generally planar wall in a direction of a central rotational axis of the wheel; a second inwardly angled wall extending inwardly from the first inwardly angled wall in the direction of the central rotational axis of the wheel and having a slope or angle that is less than a slope of the first inwardly angled wall relative to the central rotational axis of the wheel; and a hub having a center opening that is surrounded by a plurality of lug openings; the wheel face includes at least the generally planar wall.

### CROSS-REFERENCE TO RELATED APPLICATIONS

This application claims priority to US 63/786,776 filed on Apr. 10, 2025, the entirety of which is hereby incorporated by reference herein for all purposes.

### FIELD

These teachings relate to a wheel for a vehicle, and more particularly to a wheel for a vehicle that has a wheel face onto which a graphic design element is supported.

### BACKGROUND

Some vehicle owners choose to apply a graphic sheet or wrap to one or more vehicle panels for one or more reasons including customizing the appearance of their vehicle and protecting the vehicle finish against scratches, rock chips, UV exposure, and minor abrasions.

However, many vehicle wheels lack sufficient surface area or continuous regions to effectively receive a graphic sheet or wrap. Accordingly, there remains a need for a vehicle wheel design that provides increased usable surface area for application of graphic sheets or wraps, including by minimizing or reducing openings in the wheel.

### SUMMARY

These teachings describe a wheel for a vehicle, and more particularly a wheel for a vehicle having a wheel face onto which a graphic design is received.

A wheel for a vehicle is disclosed that has a disc secured to a disc support of the rim and providing a wheel face that is dimensioned and configured to support a graphic design element, the disc has a generally planar wall; a first inwardly angled wall extending inwardly from the generally planar wall in a direction of a central rotational axis of the wheel; a second inwardly angled wall extending inwardly from the first inwardly angled wall in the direction of the central rotational axis of the wheel and having a slope or angle that is less than a slope of the first inwardly angled wall relative to the central rotational axis of the wheel; and a hub having a center opening that is surrounded by a plurality of lug openings; the wheel face includes at least the generally planar wall.

A steel wheel for a vehicle is disclosed that has a steel rim comprising an inner flange, an outer flange, and an intermediate region extending between and connecting the inner flange and the outer flange, the intermediate region comprising an outer surface and an opposing inner surface, wherein a tire surrounds the outer surface of the intermediate region, the inner surface of the intermediate region comprises a disc support; a steel disc welded to the disc support of the rim and providing a wheel face that is dimensioned and configured to support a graphic design element, wherein the graphic design element comprises a front face having a graphic design and a rear face comprising an adhesive, wherein the disc comprises: an outer wall having a proximal region secured to the disc support and a distal region extending outwardly from the disc support in a direction of outer flange; a generally planar wall extending from the distal region of the outer wall; a first inwardly angled wall extending inwardly from the generally planar wall in a direction of a central rotational axis of the wheel; a second inwardly angled wall extending inwardly from the first inwardly angled wall in the direction of the central rotational axis of the wheel and having a slope or angle that is less than a slope of the first inwardly angled wall relative to the central rotational axis of the wheel; and a hub having a center opening that is surrounded by a plurality of lug openings; wherein the wheel face comprises the outer wall and the generally planar wall; wherein the graphic design element is attached to the steel wheel by applying the adhesive side of the graphic design element onto the wheel face wherein the disc and wheel face is free of any openings or cutouts in the wheel face, or the disc is free of any spokes in the wheel face; wherein the wheel is part of a vehicle that uses regenerative braking; and wherein the steel wheel comprises one or more of the following elements selected from a list consisting essentially of: the graphic design element comprises an outer perimeter that does not extend into the outer wall of the disc; the graphic design element comprises an inner region that does not extend into the second inwardly angled wall; the wheel is free of any mechanical fasteners for attaching the graphic design element to the wheel, and both of the rim and the disc are made of steel; the graphic design element comprises vinyl and an adhesive for attaching the graphic design element to the wheel face; the graphic design element comprises one or more cutouts around the inner region through which at least part of the wheel face is visible; and the wheel face comprises one or more poka-yoke features for aligning and orienting the graphic design element during installation.

### BRIEF DESCRIPTION OF THE DRAWINGS

FIG. 1 is a perspective view of a wheel and tire for a vehicle.

FIG. 2 is a perspective view of a wheel for a vehicle.

FIG. 3A is a cross-sectional view of the wheel of FIG. 2.

FIG. 3B is a cross-sectional view of the wheel of FIG. 2.

FIG. 4 is a front view of a plurality of graphics.

FIG. 5 is a front view of a plurality of wheels with graphics.

FIG. 6 is a cross-sectional view of a wheel and graphic design element.

FIG. 7 is a front perspective view of a vehicle comprising the wheels according to the teachings herein.

FIG. 8 is a front perspective view of a vehicle comprising the wheels according to the teachings herein.

### DETAILED DESCRIPTION

These teachings relate to a wheel for a vehicle, and more particularly to a wheel for a vehicle that has a wheel face onto which one or more graphic design elements is/are supported. The graphic design element may function to allow a user or owner to increase the aesthetic appearance of their wheel(s), vehicle, or both. The graphic design element may function to protect the rim or wheel face of the rim against scratches, rock chips, UV rays, and minor abrasions.

The wheel may be used for vehicular applications, such as, for example, an automobile, pickup truck, sport utility vehicle, van, or a combination thereof. The vehicle may be a commercial vehicle or passenger vehicle. The vehicle may be powered by an internal combustion engine, a battery, and/or a hybrid combination of an internal combustion engine and battery.

The wheel may be used with the reconfigurable vehicle illustrated and described in US 63/785,542 filed on Apr. 08, 2025, US 63/788,545 filed on Apr. 14, 2025, US 63/792,518 filed on Apr. 22, 2025, and/or U.S. Patent Application No. 19/642,294 filed on Apr. 08, 2026, the entireties of which are all hereby incorporated by reference herein for all purposes.

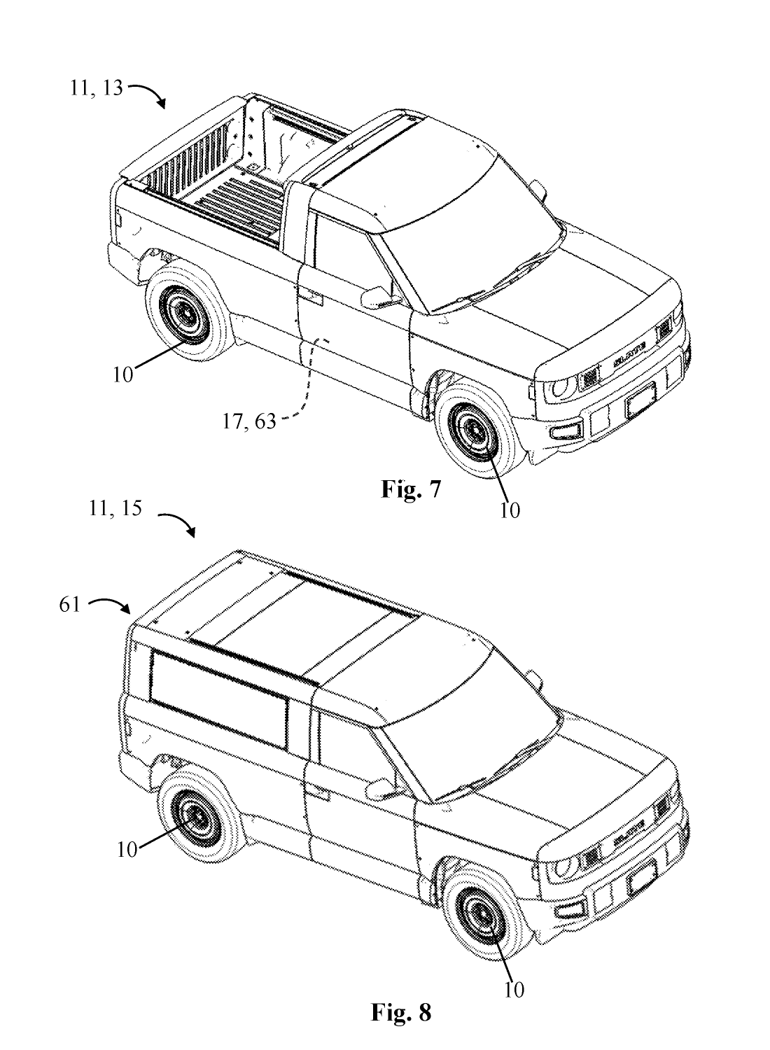

For example, the vehicle in the aforementioned US provisional application that is incorporated by reference in its entirety is reconfigurable between a pickup truck configuration (e.g., FIG. 7 herein) and a sport utility (SUV) configuration (e.g., FIG. 8 herein), and has a frame comprising a front region that is located generally over a pair of front wheels of the vehicle and a rear region that is located generally over a pair of rear wheels of the vehicle, rear region having a pair of opposing bed walls and a rear floor, wherein frame comprises one or more frame fastening devices; a rear enclosure assembly configured to attach to the one or more preexisting fasteners on the frame to reconfigure the vehicle from the pickup truck configuration to the SUV configuration, the rear enclosure assembly comprising: i) a roll bar assembly comprising a hoop structure having a pair of spaced apart pillars, an upper cross bar connected to upper regions of the pillars, and optionally a lower cross bar; and ii) one or more rear passenger seats configured for attachment to the vehicle frame through the lower crossbar; the hoop structure is attached to the opposing bed walls and/or the rear floor of the frame.

The vehicle wheel may be part of a vehicle that can be reconfigured back to a first vehicle configuration (from a second vehicle configuration). In other words, the vehicle has a reversible configurable structure.

In the context of the present description, “reversibly configurable” refers to structure having ability to be reconfigured (e.g., converted or transformed) from a first configuration to a second configuration and back to the first configuration. In this regard, “reversibly configurable” includes an ability of a structure to be reconfigured without permanently altering the structure in a way that would inhibit the structure from being reconfigured back to a previous configuration. For example, the structure may be reversibly configured from and/or between the first vehicle configuration to a second vehicle configuration without using permanent fasteners like adhesives or welding. For example, the structure may be reversibly configured from and/or between a first vehicle configuration to a second vehicle configuration without the need for using destructive material removal techniques causing permanent deformation such as cutting, milling, grinding, etc.

A rear enclosure assembly may be attached to one or more preexisting fasteners on the vehicle frame to reconfigure the vehicle from the pickup truck configuration to the SUV configuration. The use of the preexisting fasteners enables installation without drilling, welding, cutting, or otherwise permanently altering the vehicle frame.

As used herein, “preexisting” refers to fastening features incorporated into or on the vehicle frame by the original vehicle manufacturer during original manufacture and prior to the vehicle being placed into service. For example, the plurality of preexisting frame fastening devices comprise threaded fasteners, weld nuts, threaded bores, or combinations thereof installed prior to reconfiguration of the vehicle. The rear enclosure assembly is attachable to the vehicle frame without welding, bonding, cutting, drilling, or grinding the vehicle frame. The rear enclosure assembly is removable from the vehicle frame to return the vehicle to the pickup truck configuration using the plurality of preexisting frame fastening devices.

One of the vehicle configurations (e.g., first vehicle configuration or second vehicle configuration) may be a pickup truck or pickup truck configuration. The other vehicle configuration (e.g., first vehicle configuration or second vehicle configuration) may be a sport utility vehicle (SUV) or SUV configuration.

A “pickup truck” includes a vehicle that may be a light, medium-duty or heavy-duty truck. The pickup truck configuration may include a vehicle having an enclosed cab or cockpit (for at least a driver and at least one occupant) and an open cargo area, namely a bed, located in the rear portion of the vehicle and being operable for storing and/or transporting cargo. A pickup truck configuration may be a vehicle that does not include a C-pillar, e.g., does not include a C-pillar that defines part of a passenger cab. A pickup truck configuration may be a vehicle that does not include a D-pillar. A pickup truck configuration may be a vehicle that has a removable bulkhead panel and rear window or glass assembly that can be completely removed or separated from the vehicle. A pickup truck may have 2 doors.

A “sport utility vehicle” includes a vehicle that may be a light, medium-duty or heavy-duty vehicle including an enclosed cab (for at least a driver and at least one and preferably a plurality of occupants), a cargo area enclosed by an enclosure, and a space behind a driver seat for or providing additional passenger seating. Thus, a “sport utility vehicle” includes a vehicle that is configured to receive at least one rear seat, at least one seat belt, and at least one air bag (e.g., a side curtain airbag mounted in an upper part of the vehicle adjoining an edge portion of the vehicle roof). When the vehicle is converted into the SUV configuration, C- and D-pillars may be added.

The wheel may be used with a vehicle that has a braking system utilizing regenerative braking, electro-mechanical braking, or hydraulic braking.

In other configurations, the wheel may be used with land-based vehicles, including passenger cars, trucks, sport utility vehicles (SUVs), vans, buses, motorcycles, all-terrain vehicles (ATVs), utility task vehicles (UTVs), side-by-side vehicles, recreational vehicles (RVs), construction vehicles, agricultural vehicles, and trailers. More generally, the disclosed concepts may be applied to any transport or recreational platform utilizing wheels, regardless of propulsion type or operating environment.

The wheel may include a rim and a disc. The rim and the disc may be made from a single integral structure. The rim and the disc may be made from two or more structures that are connected or attached together via a welding process. The rim and the disc may be made from the same material. The rim and the disc may be made from different materials. For example, the rim, the disc, or both may be made from steel, aluminum, or a combination thereof.

The wheel or rim may be a 14 inch wheel or less, a 15 inch wheel, a 16 inch wheel, a 17 inch wheel, an 18 inch wheel, a 19 inch wheel. The wheel may be 20 inches or more. A tire may be mounted on the rim. Preferably the wheel and tire size is 29.5” 245/65R17.

The rim, the disc, the one or more wheel faces, or a combination thereof may include one or more surface finishes that enable it to support one or more graphic designs. For example, the one or more surface finishes may enable an adhesive of the one or more graphic designs to stick to the surface and prevent unwanted peeling or separation of the graphic design from the wheel face. On the other hand, the one or more surface finishes may enable an adhesive of the one or more graphic designs to be removed from the surface if a user wishes to remove the graphic design from the wheel.

For example, the surface finish may include a machined finish, a smooth finish, a roughed or textured finish, a chrome finish, a painted finish, a non-painted or coated finish, a coated finish, or a combination thereof. The surface finish may include a glossy or matte finished protective clear coat, powder-coated paint, low surface energy plastics and fiberglass, or a combination thereof. By way of example, it is possible that the surface to which the graphic design element is to be applied is subjected to a treatment for altering a surface energy characteristic as compared with a pre-treatment surface energy characteristic; for example, to increase the surface energy for improving bonding.

In some instances, the surface finish may include a surface texture comprising a microtexture formed on the surface. The surface texture may includes a plurality of grains or projections distributed across the surface. The grains or projections may be formed integrally with the substrate (e.g., molded-in texture) or applied in a secondary process.

The plurality of grains or projections may define a textured profile having a peak-to-valley height (or depth) of less than about 0.1 mm. In some embodiments, the grains or projections may have a height in a range of about 0.02 mm to about 0.1 mm, and more particularly about 0.03 mm to about 0.06 mm. In certain implementations, the grain height may be approximately 0.02 mm, 0.03 mm, or 0.06 mm.

In some instances, a primer and/or adhesive promoter may be applied onto the rim, the disc, the one or more wheel faces, or a combination thereof to enhance adhesion.

The bond to the surface may be achieved by way of an adhesive bond that employs a chemical bond, a mechanical bond, or a combination; and/or an adhesive bond due to an attraction between an adhesive and molecules of an underlying substrate molecules, such as through van der Waals forces or hydrogen bonds. The bond to the surface may be sufficiently high so as to resist prevent unwanted peeling or separation of the graphic design element from the wheel face to which it is attached under typical operating conditions.

The wheel may include one or more wheel faces. A wheel face may be dimensioned and configured to support one or more graphic designs. A wheel face may include or may be one or more surfaces, angles, profiles, planes, or walls of the wheel. A wheel face may be one or more parts or regions of the wheel that are at least partially visible to a person that is outside of the vehicle. A wheel face may include or may be one or more surfaces, angles, profiles, planes, or walls of the wheel that are arranged laterally and/or angularly away from the vehicle. A wheel face may include one or more class A surfaces.

A wheel face may comprise any of the faces or surfaces of the disc disclosed herein. A wheel face may comprise any of the faces or surfaces of the rim disclosed herein. A wheel face may comprise two or more adjacent surfaces or walls of the rim, disc, or both. A wheel face may comprise two or more non-adjacent surfaces or walls of the rim, disc, or both. Stated another way, this may mean that a wheel face may include a first surface, an adjacent second surface is omitted, and includes a third surface that is adjacent to the second surface.

A wheel face may comprise one or more of any of the following surfaces or features of the wheel: the outer flange, the outer wall of the disc, the planar wall of the disc, the first inwardly angled wall of the disc, the second inwardly angled wall of the disc, the hub, a cap that encloses the hub, one or more regions around the lug openings, caps that go over the lug nuts, or any combination thereof.

A wheel face may omit or not include one or more of any of the following surfaces or features of the wheel: the outer flange, the outer wall of the disc, the planar wall of the disc, the first inwardly angled wall of the disc, the second inwardly angled wall of the disc, the hub, a cap that encloses the hub, one or more regions around the lug openings, caps that go over the lug nuts, or any combination thereof.

The wheel face, the one or more surfaces defining the wheel face, the disc, or a combination thereof may be free of any openings, cutouts, and/or spokes. In this regard, the wheel face may comprise one or more surfaces that are free of any through-openings, cutouts, spokes, or voids. Advantageously, this gives the wheel face a larger, solid, and continuous surface to ensure proper adhesion of the graphic design element. In one aspect, the design of the wheel is unique in that the face of the wheel has an overall surface area. The overall surface area may be continuous. The overall surface area may be devoid of through hole openings. The overall surface area of the wheel face that is solid and continuous may be at least 70% and more preferably at least 80% or even at least 90% of the surface area that would be present without the through hole openings. Thus, it is possible that through-hole openings are formed over less than 30%, more preferably, less than 20% and still more preferably less than 10% of available surface area of the wheel. The number of through hole openings in the wheel face (excluding any made for pneumatic valve stems) may be less than 10, more preferably less than 8, and still more preferably less than 6 or 4.

In some configurations, the wheel, wheel face, and/or disc may include one or more openings that do not significantly reduce the wheel face and/or surface area for adding a wrap. This opening may be an opening for the tire valve stem. Additionally or alternatively, one or more openings, cutouts, and/or spokes may be added in or to the wheel face and/or disc.

One or more graphic design elements may be supported or attached on or to the wheel face. One or more graphic design elements may be supported on one or more of the surfaces or features of the wheel that define the wheel face. The one or more graphic design element may comprise or consist of a polymeric layer (e.g., in a film form, such as a cast film form) and an adhesive layer. The polymeric layer may have an outer facing surface (i.e., an A-surface, facing away from the wheel surface upon installation), that is decorative. The polymeric layer may have an inner facing surface (i.e., a B-surface, facing toward the wheel surface upon installation) that is coated with an adhesive or adhesive layer. One of the layers may be a tie coat layer.

The one or more graphic design elements may be provided in a layer form, such as in the form of one or more decals, stickers, overlays, patterns, labels, films, foils, or a combination thereof. The layer form may have a generally constant thickness. The layer form may comprise one or a plurality of polymeric layers (e.g., it may comprise a laminate of two or more layers or films). The one or more graphic design elements may function to elevate the appearance of the one or more wheels, the vehicle, or both. The one or more graphic design elements may allow a user or owner to customize the look of their wheel, vehicle, or both, rather than rely on standard product offerings from a wheel or vehicle manufacturer. As can be seen from the above, the one or more graphic design elements may be provided as a continuous solid state form. The one or more graphic designs may be provided form other than by spraying.

The graphic design element may include a clear coat outer layer. For example, there may be a clear coat outer layer that includes a polyurethane. The graphic design element may also include an image imparted to it in accordance with the teachings of US2013/0237130A1, incorporated by reference in its entirety. The image may be formed by a mask applied over a layer (e.g., over a clear coat or other outer layer), followed by abrasion of the unmasked material, and removal of the mask to reveal a matter finish and an unabraded region.

One or more of the layers may be disclosed in US 10,301,512, the entirety of which is incorporated by reference.

The graphic design element may have a structure that is flexible and resilient, and as such will not plastically deform during ordinary installation steps. The graphic design element may have a structure that is not capable of supporting its own weight (i.e., when held at one of its longitudinal ends, it will sag due to gravity). The graphic design element may have a structure that is capable of supporting its own weight (i.e., when held at one of its ends transverse to its longitudinal axis, it will not sag due to gravity).

The one or more graphic design elements may be made of one or more polymeric materials. The one or more polymeric material may be derived from the polymerization of monomers containing a vinyl group (H2C=CH-). The one or more polymeric material may be derived from an olefin, e.g., an α-olefin. The one or more polymeric material may be halogenated, free of halogenation. The one or more polymeric materials may be a urethane derived material (e.g., a material derived from a reaction of an isocyanate with a polyol). Examples of suitable materials include polyvinyl chloride, thermoplastic polyurethane (e.g., and aliphatic thermoplastic polyurethane). The one or more polymeric materials may be or may comprise an acrylic. The one or more graphic design elements may be made of one or more materials that are resistant to sunlight (UV), temperature, humidity, salt-spray. The one or more graphic design elements may be made of a material that is generally scratch resistant and/or self-healing. “Self-healing” refers to the ability to return to an original appearance after being deformed, such as due to scratching or abrasion. The one or more graphic design elements may include a polymeric layer configured with micro-channels for enabling escape of trapped air during installation (and thus avoiding bubble formation). Examples of other polymers that may be suitable for use as a layer in the graphic design element of the present teachings include a polyester such as a polyethylene terephthalate, a polyimide, and/or a polycarbonate; and the like.

As noted above, the one or more graphic design elements may have an A-surface that carries a decorative element. The A-surface may face outwardly or away from the one or more wheel faces, and upon installation the surface may be inclined relative to an axis orthogonal of the wheel rotational axis of less than 45°, and preferably less than 30°. The A-surface may display one or more pictures, images, patterns, designs, colors, logos, fonts, letters, numbers, marketing materials, political signs, or a combination hereof.

The one or more graphic design elements may be over-laminated or clear coated with a UV screen print clear layer over or on top of the A-surface.

The one or more graphic design elements may have a B-surface. The B-surface may face towards the one or more wheel faces. The B-surface may be in contact with the one or more wheel faces, e.g., indirectly through the adhesive.

The B-surface may comprise one or more adhesives to attach or connect the one or more graphic design elements to the one or more wheel faces. The adhesive may be a high-tack adhesive that is configured for adhesion to glossy and matte finished protective clear coats, powder-coated paints, low surface energy plastics and fiberglass, or a combination thereof. The adhesive may include a pressure-sensitive adhesive, a high-tack adhesive.

The adhesive or adhesive layer may be covered or protected by one or more release layers, such as one or more carriers, foils, or backings that must be removed to expose the adhesive. A release layer may be a low friction or energy material that is easily removed or separatable from the adhesive or back side of the polymeric layer to expose the adhesive layer. The release layer may be of the type disclosed in US 2018/0079187A1 (e.g., paragraphs [0086-0092]), incorporated by reference in its entirety.

Additionally, or alternatively, an adhesive may be applied to the back side of the graphic design element and/or the wheel face. Such an adhesive may be applied as a paste, liquid, spray, or a combination thereof. The adhesive may include a pressure sensitive adhesive. The adhesive may include one or more acrylic compounds.

The adhesive or adhesive layer may include one or more ingredients such as a light stabilizer (e.g., a hindered amine light stabilizer such as a NOR-HALS stabilizer). An example of a suitable UV additive may be found in US 2015/0086782 A1, incorporated by reference in its entirety, See e.g., paragraphs [0053-0077] and paragraph . Other additives may be in the adhesive layer such as an antioxidant, a tackifier, a softener, a filler, a colorant, a flame retardant or otherwise.

Other adhesive systems may be employed including but not limited to adhesives based upon vinyl acetate, rubbers, and/or silicones, See also US 2018/0079187A1 (e.g., paragraphs [0077-0085]), incorporated by reference in its entirety.

Examples of acrylic based adhesive systems useful in accordance with the present teachings are found in US 10,550,297 B2 (e.g., columns 4-5) incorporated by reference in its entirety.

The graphic design element may include a clear coat outer layer. For example, there may be a clear coat outer layer that includes a polyurethane.

The graphic design element may be free of any mechanical fasters for attaching the graphic design element to the wheel or the wheel face. Such mechanical fasteners may include clips, pins, screws, rivets, or a combination thereof.

The polymeric material layer of the graphic design element may be capable of functioning without degradation visible to the naked eye, under midday sunlight, from a distance of two meters of over a temperature range of -50 to 85° C.

The adhesive layer of the graphic design element may be capable of exhibiting a peel strength to the surface of the wheel face, of at least 600 N/m, and preferably at least 650 M/m, and more preferably at least 700 or 750 N/m. The graphic design element may withstand a 90 Degree peel adhesion test in accordance with testing standard ASTM D6862-11.

The peel strength may have an initial peel strength of 1.5 lbf/in maximum.

The peel strength may be 1.5 lbf/in minimum after 24 hour dwell time in ambient

The peel strength may be 1.0 lbf/in minimum after 72 hour heat aged at 80C.

The face stock may have a thickness of approximately 3 millimeters.

The adhesive layer may be covered or protected by a linear that is removed prior to application onto the vehicle wheel or surface thereof.

The polymeric material of the graphic design element may be capable of exhibiting a flexural modulus of at least 45 MPa), and more preferably at least 55 MPa per ASTM D790-17. The polymeric material of the graphic design element may be capable of exhibiting a flexural modulus of no more than 150 MPa, and more preferably no more than 110 MPa per ASTM D790-17. The polymeric material of the graphic design element may be capable of exhibiting an ultimate tensile strength of at least 50 MPa, and more preferably at least 60 MPa per either or both of ASTM D882-18. The polymeric material of the graphic design element may be capable of exhibiting an ultimate tensile strength of no more than 150 MPa, and no more than 100 MPa per either or both of ASTM D882-18. The polymeric material of the graphic design element may be capable of exhibiting an elongation at break of at least 250%, more preferably at least 300% and still more preferably at least 350%, per either or both of ASTM D882-18. Unless otherwise stated in a specified standard, all testing herein assumes testing at room temperature (23° C.).

One or more different effects may be imparted to the graphic design element including but not limited to the formation of a diffraction grating over at least a portion of the polymeric material layer (e.g., as a coating and/or sub-layer), as described in US 2022/0227315, incorporated by reference in its entirety for all purposes. The film may otherwise be processed to include a texture on or within a layer, such as is described in WO/2019/169079 A1, incorporated by reference in its entirety.

Decorative elements can be formed in and/or on the polymeric film layer, the adhesive layer or both. For example, the adhesive layer may have an image that can be seen through a transparent or translucent polymeric film layer.

For all of the teachings herein, unless described as being limited to a monolayer, may include a plurality of sublayers (e.g., a laminate of a plurality of films).

Decorative elements can be formed in and/or on the polymeric film layer, the adhesive layer, or both. For example, the adhesive layer may have an image that can be seen through a transparent or translucent polymeric film layer. Examples of techniques suitable for forming decorative elements are illustrated in US 10,981,371 B2, incorporated by reference in entirety for all purposes.

In one example, the graphic design element may comprise one or more elements, features, or characteristics of the Avery DennisonⓇ MPI 1106 Hi-Tack Easy Apply premium cast film, Avery DennisonⓇ MPI 1105 Wrapping Film, Avery DennisonⓇ MPI 1060 Transparent film. The graphic design element may comprise a digitally printable film.

The graphic design element may also include an image imparted to it in accordance with the teachings of US2013/0237130A1, incorporated by reference in its entirety. The image may be formed by a mask applied over a layer (e.g., over a clear coat or other outer layer), followed by abrasion of the unmasked material, and removal of the mask to reveal a matter finish and an unabraded region.

The graphic design element will withstand rock chip testing in accordance with SAE J400. The graphic design element may be capable of withstanding impact from particles, such as airborne debris, stones, sand particles, etc., which may hit the film surface at high speeds. To evaluate the impact resistance, the graphic design element is evaluated using an ASTM D968-93 testing method. The graphic design element may resist degradation, stone shipping, peeling, UV fading, salt spray degradation, scratching, or other failure for a period of at least 1 year, preferably at least 2 years, more preferably at least 5 years. The graphic design element may have an outer surface that resists scratching or destruction due to curb damage when the wheel or disc comes into contact with a curb or other rough surface.

The graphic design element may adhere to the wheel surface for a period of at least one year without major defects in appearance such as peeling, cracking, shrinking, or fading.

The graphic design element may be removable without any permanent defect to the surface materials.

The graphic design element may have an embossed look.

The outer exposed surface of the graphic design element may have a hydrophobic topcoat, a high gloss finish with no orange peel finish or a matte finish.

The graphic design element may comprise a thickness on the order of about 1mm to about 7mm. This thickness may be inclusive of only the A-surface, or both of the A-surface and the adhesive.

In other configurations, the adhesive can be a spray or paste that is applied to the graphic design element, one or more wheel faces, or both, before attaching the graphic design element to the one or more wheel faces.

The graphic design element may be configured as a single-use application. This means that after the graphic design element is applied to the one or more wheel faces, it cannot be removed without damaging the graphic design element. In other configurations, the graphic design element may be configured as a multi-use application. This means that the graphic design element can be installed on the one or more wheel faces, removed, and then re-applied onto the one or more wheel faces. A single-use application may allow for the graphic design element to better adhere to the wheel face. A multi-use application may allow for ta user to reposition the graphic design in case the graphic design element is not applied correctly or straight the first time.

The wheel, the one or more wheel faces, or both, may include one or more poka-yoke features. A poka-yoke feature may help a user align and/or orient the one or more graphic design elements in a proper orientation or location on the wheel or wheel face during installation or application. For example, the one or more poka-yoke feature may include one or more projections, lines or scribe marks, apertures, ribs, or a combination thereof.

A method of applying the one or more graphic design elements to a wheel or one or more wheel faces is disclosed. The method may include one or more steps of cleaning the wheel or the one or more wheel faces. The cleaning step is aimed at removing dust, mud, gunk, water, or any other contaminants from the one or more wheel faces to ensure the graphic design element adheres directly to the wheel face.

The method may include a step of preparing the graphic design element. This may include removing a backing from the graphic design element to expose the adhesive. Additionally or alternatively, an adhesive may be applied to the wheel or to the back side of the graphic design element.

The method may include a step of aligning the graphic design element with one or more poka yokes to ensure the graphic design element is properly aligned and centered relative to the wheel and the wheel faces.

The method may include a step of applying pressure to the graphic design element to “wet” the adhesive. The pressure may be applied by the hand or fingers of an owner or installer of the graphic design element, a squeegee, or other tool. This step may also function to push any air or water bubbles to the edges of the wheel until expelled.

It is understood that any of the method steps can be performed in virtually any order and are not necessary to be in the order disclosed herein unless otherwise noted. One or more of the steps can be combined with one or more other steps; one or more steps can be omitted or eliminated; one or more steps can be repeated or duplicated; one or more steps can be split into two or more steps; one or more of the steps can be rearranged in a different order relative to other method steps; or any combination hereof.

The graphic design element of the present teachings may be applied to a wheel. The wheel may be part of an assembly that includes one or any combination of a tire (e.g., a pneumatic tire, a run-flat tire, a tire pressure monitoring sensor, any combination thereof, or otherwise). The wheel may be part of a corner assembly that includes a brake assembly (e.g., a regenerative brake assembly), one or more suspension components (e.g., a suspension assembly that includes an arm upon which a spring is mounted), or any combination thereof.

The wheel may be used with a regenerative braking system. Such braking systems may create or generate less heat compared to traditional hydraulic brake systems. The less heat generated by the brake system may be advantageous in that the graphic design element or adhesive does not melt or otherwise cause the adhesive layer to separate from the wheel face.

A kit is also disclosed herein. A kit may comprise one or more of the following: one or more graphic design elements, one or more wheels, one or more tools for applying or installing the graphic design element on the wheel (such as a squeegee for example), one or more tools for removing the graphic design element from the wheel, or a combination thereof. The kit may also include a graphic design element for covering one or more vehicle body panels, such as a door panel, front fender, rear fender, hood, trunk lid, bumper, or a combination thereof. The kit may include an instruction video, manual, or brochure for installing or applying the graphic design element to the wheel face, as disclosed herein. The kit may include a cleaning solution or cleaning the wheel face before applying the graphic design element. The cleaning solution may be alcohol, soap, or other mixture.

FIG. 1 illustrates a tire 10 mounted on a wheel 12 for a vehicle.

The wheel 12 may include a rim 14 and a disc 16. The wheel 12, the rim 14, and/or the disc 16 may include one or more wheel faces 18 onto which one or more graphic design elements is/are supported (FIGS. 4-6).

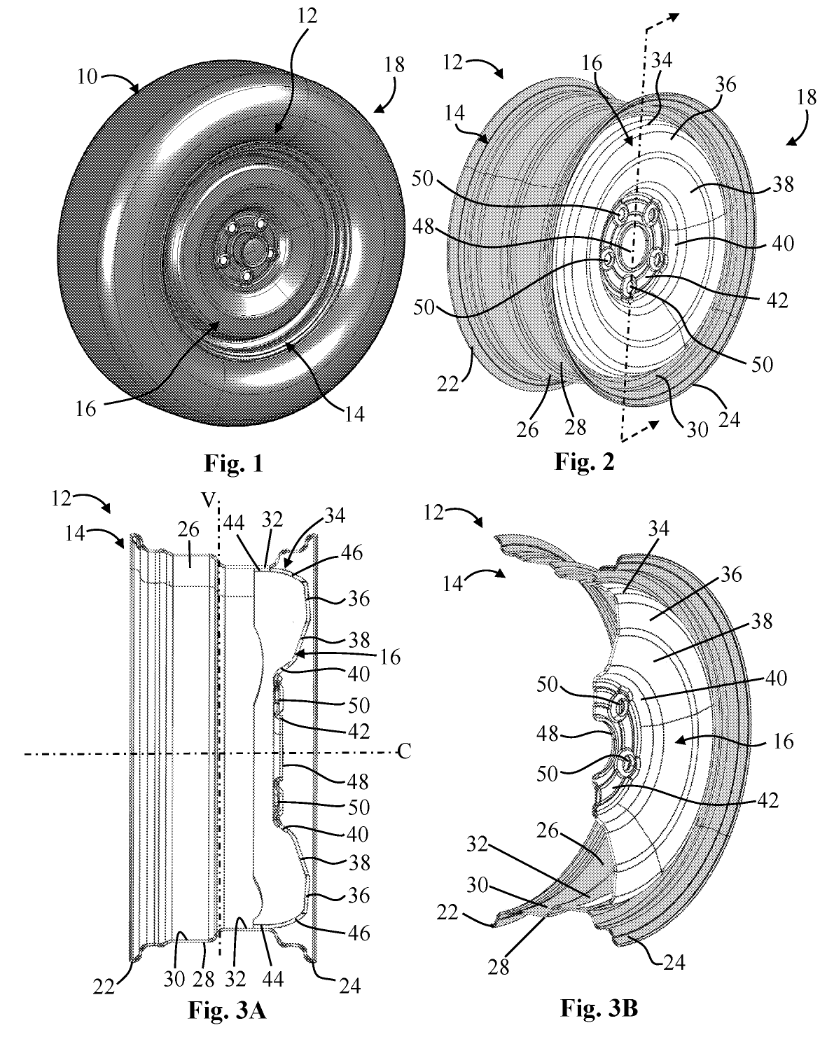

With additional reference to FIGS. 2, 3A, and 3B, the rim 14 may comprise an inner flange 22, an outer flange 24, and an intermediate region 26 extending between and connecting the inner flange 22 and the outer flange 24. The intermediate region 26 may comprise an outer surface 28 and an opposing inner surface 30. The tire 10 may be configured to be mounted onto and surround the outer surface 28 of the intermediate region 26 between the inner and outer flanges 24, 26. The inner surface 30 of the intermediate region 26 may comprise a disc support 32. The disc 16 may be attached or secured to the disc support 32 of the rim 14. The disc 16 may be attached or secured to the disc support 32 of the rim 14 via one or more attachment methods, such as welding. In other configurations, the disc 16 may be integrally formed with the support 32.

The disc 16 may include or may be defined by one or more walls. The one or more walls may be formed from a single wall or structure that is formed into the geometry disclosed herein. For example, one or more casting, stamping, cutting, or other forming operations may be used to form the walls disclosed herein. In other configurations, the one or more walls may be formed from two or more walls or structures that are joined together via a joining method such as welding.

The one or more walls of the disc 16 may include or define an outer wall 34, a generally planar wall 36, a first inwardly angled wall 38, a second inwardly angle wall 40, and a hub 42.

The outer wall 34 may include a proximal region 44 that is secured to the disc support 32 and a distal region 46 extending outwardly from the disc support 32 in a direction of outer flange 24.

The proximal region 44 of the outer wall 34 may be substantially horizontal to ensure a good connection to the disc support 32. In other words, the proximal region 44 of the outer wall 34 and the disc support 32 may overlap or be in a planar relationship to one another.

The distal region 46 of the outer wall may be slightly angled or curved relative to a horizontal plane or center rotational axis C. For example, the distal region 46 of the outer wall may be angled relative to the rotational axis C at about 5 degrees or more, 10 degrees or more 20 degrees or more, 30 degrees or more.

The generally planar wall 36 may extend from the distal region 46 of the outer wall 34. The generally planar wall 36 may be substantially perpendicular to a center axis C. The generally planar wall 36 may be angled relative to an axis or plane V that is vertical or perpendicular to the center rotational axis C. The generally planar wall may extend at an angle measured from a vertical plane V that is perpendicular to a central rotational axis C of the wheel by an angle more than about 0 degrees and less than about 10 degrees, preferably about 5 degrees. In some configurations, the angle may be 5 degrees or more, 10 degrees or more, 15 degrees or more, 20 degrees or less.

The first inwardly angled wall 38 may extend inwardly from the generally planar wall 36 in a direction of a central rotational axis C of the wheel 12. The first inwardly angled wall 38 may be angled relative to or away from an axis or plane V that is vertical or perpendicular to the center rotational axis C. The first inwardly angled wall may extend at an angle measured from a vertical plane that is perpendicular to a central rotational axis of the wheel by an angle of more than about 10 degrees and less than about 45 degrees, preferably about 20 degrees. In some configurations, the angle may be about 5 degrees or more, 10 degrees or more, 15 degrees or more, 20 degrees or more, 30 degrees or more, or about 45 degrees or less.

The second inwardly angled wall 40 may extend inwardly from the first inwardly angled wall 38 in the direction of the central rotational axis C of the wheel 12. The second inwardly angled wall 40 may have a slope or angle that is less than a slope of the first inwardly angled wall 38 relative to the central rotational axis C of the wheel 12. In an embodiment, the second inwardly angled wall 40 may have a slope or angle that is the same as or greater than a slope of the first inwardly angled wall 38 relative to the central rotational axis C of the wheel 12.

The second inwardly angled wall 40 may be angled relative to or away from an axis or plane V that is vertical or perpendicular to the center rotational axis C. The second inwardly angled wall may extend at an angle measured from a vertical axis or plane V that is perpendicular to a central rotational axis of the wheel by an angle of more than about 30 degrees and less than about 70 degrees, preferably about 55 degrees. In some configurations, the angle may be about 20 degrees or more, 30 degrees or more, or about 45 degrees or more, 50 degrees or more, 60 degrees or more, or 75 degrees or less.

The hub 42 may have or define a center opening 48 that is surrounded by a plurality of lug openings 50. In the illustrated embodiment, the hub 42 has five (5) equally spaced lug openings 50. However, the hub 42 may include any number of lug openings 50.

When viewed in cross section, none of the walls of the disc, including the generally planar wall 36, extend laterally beyond the outer flange 24. Instead, all of the walls of the disc are recessed or arranged within the outer flange 24 or within a radial envelope defined by the outer flange 24. Stated differently, the outer flange 24 defines the outermost boundary of the wheel, and the disc is positioned inward of that boundary. This may be important so that any wrap or graphic that is applied onto the wheel faces is not damaged or scratched if the wheels or rim contact an obstruction, such as a curb for example, because the outer flange 24 would be the first portion of the wheel to contact obstruction. Accordingly, the flange 24 may act as a protective structure that shields the recessed disc surfaces. As a result, contact forces, abrasion, and scraping are absorbed primarily by the outer flange rather than the disc. Accordingly, any wrap, coating, or graphic applied to the disc is less likely to experience direct contact with external obstructions, thereby reducing the likelihood of scratching, peeling, tearing, or other damage. This arrangement may improve durability and maintain the aesthetic appearance of the wheel over time, particularly in typical curb-contact scenarios.

FIG. 4 illustrates a plurality of graphic design elements 20. Each of the graphic design elements 20 comprises a generally circular or ring member 52 having an outer perimeter 54, an inner perimeter 56, and a graphic face 58 extending or defined therebetween 54, 56. The graphic has an A-side and an opposing B-side. After the graphic design element 20 is attached to and/or supported on the one or more wheel faces of the wheel, the A-side is visible or laterally facing outward. The opposing B-side may include an adhesive that is used to attach or secure the graphic design element 20 to the wheel or more specifically to the one or more wheel faces 18.

In an embodiment, the graphic design element 20’ comprises an outer perimeter 54 and an inner region 56’ that defines a plurality of cutouts 60’ that define spokes that radiate from a central part of the graphic design element 20’. The cutouts 60’ may be an absence of material. In this embodiment, the graphic design element 20’ has six (6) spokes 60’ extending equidistantly around the central inner region 56’.

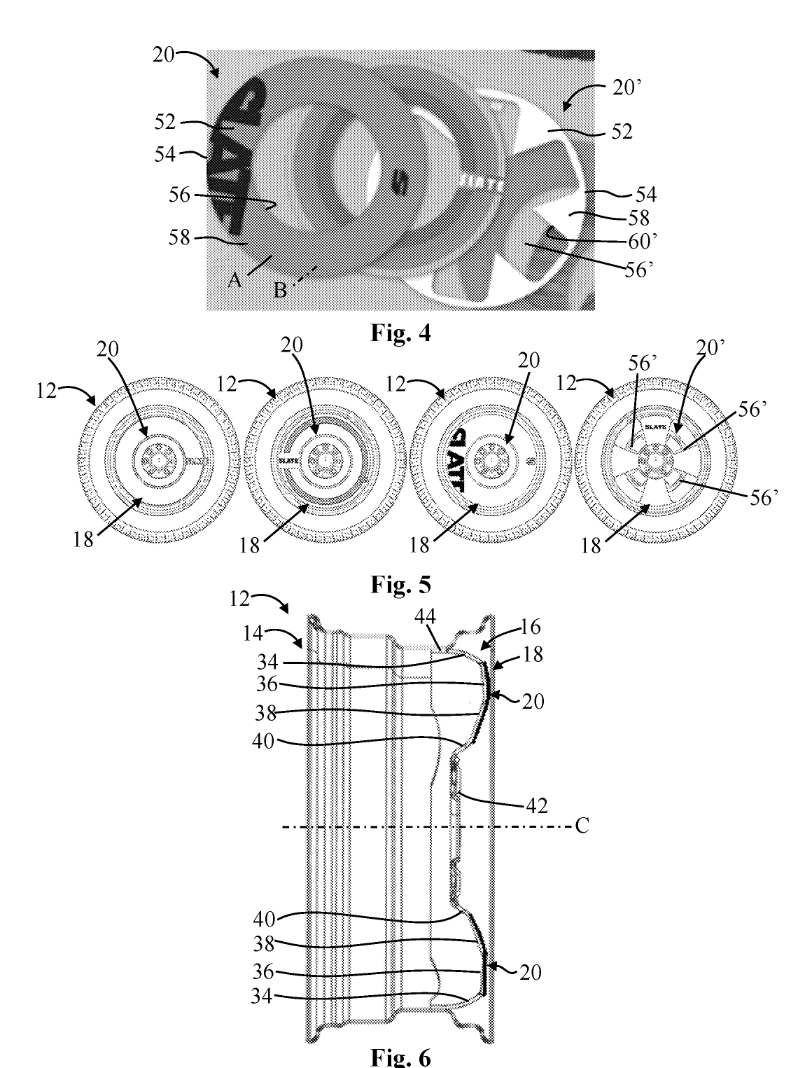

FIG. 5 illustrates a plurality of wheels 12 for a vehicle. The wheel 12 comprises a rim and a disc 16. The wheel 12, rim, and/or disc comprises one or more wheel faces 18 onto which a graphic design element 20 is attached and/or supported.

Referring to the far right wheel 12, the graphic design element 20 comprises a plurality of cutouts 60’ around a central part of the graphic design element 20’. In this embodiment, parts of the wheel faces 18 remain visible through the cutouts 60’.

In an embodiment, rather than the cutouts 60’ being an absence of material, the cutouts 60’ may be a clear or transparent portion of the graphic design element 20’. In this regard, the wheel faces 18 are covered by the graphic design element 20’ but are still visible through the transparent parts of the graphic design element 20.

FIG. 6 is a cross-sectional view of the wheel 12. The wheel 12 comprises a rim 14 and a disc 16 attached to the rim 14. The disc 16 comprises one or more wheel faces 18 onto which the graphic design element 20 is applied. The wheel faces 18 comprise the planar wall 36 and the first inwardly angled wall 38. In this embodiment, the other faces including the outer wall 34, the second inwardly angled wall 40, and the hub 42 are free of being covered by the graphic design element 20.

In an embodiment, one or more of any of the walls 34, 36, 38, 40, 42 may be at least partially covered by the graphic design element 20.

FIGS. 7 and 8 illustrate a vehicle 11 having wheels 10 according to the teachings herein. The wheel 10 may be a front wheel and/or a rear wheel.

The vehicle 11 is reconfigurable between a pickup truck configuration 13 and a sport utility vehicle (SUV) configuration 15. The vehicle includes a vehicle frame 17 configured to support both the pickup truck configuration 13 and the SUV configuration 15 and to allow reconfiguration therebetween without permanently modifying the vehicle frame 17. The vehicle may be reversibly reconfigurable between the two configurations or vehicle states 13, 15.

A rear enclosure assembly 61 may be attached to one or more preexisting fasteners 63 on the vehicle frame 17 to reconfigure the vehicle from the pickup truck configuration 13 to the SUV configuration 15. The use of the preexisting fasteners 62 enables installation without drilling, welding, cutting, or otherwise permanently altering the vehicle frame 17. As used herein, “preexisting” refers to fastening features incorporated into or on the vehicle frame by the original vehicle manufacturer during original manufacture and prior to the vehicle being placed into service.

The rear enclosure assembly 61 may include a roll bar assembly, a hoop structure defined by opposing pillars and at least one cross bar extending therebetween, and a rear seat assembly. One or more of these components may be attached to the vehicle frame 14 via the preexisting fasteners 17 such that occupant loads from the rear seat assembly are transferred to the vehicle frame 17. In some configurations, the roll bar assembly and associated structure are configured to provide defined load paths and structural performance sufficient to comply with applicable federal crash and rollover standards.

Further aspects of the vehicle 11, the one or more configurations or states 13,15, the rear enclosure assembly 61, and elements thereof are disclosed in U.S. Patent Application No. 19/642,294 filed on Apr. 08, 2026, the entirety of which is incorporated herein by reference.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of "a" or "one" to describe an element or step is not intended to foreclose additional elements or steps. For example, disclosure of “a motor” does not limit the teachings to a single motor. Instead, for example, disclosure of “a motor” may include “one or more motors.”

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The invention illustratively disclosed herein suitably may be practiced in the absence of any element which is not specifically disclosed herein.

Any of the elements, components, regions, layers and/or sections disclosed herein are not necessarily limited to a single embodiment. Instead, any of the elements, components, regions, layers and/or sections disclosed herein may be substituted, combined, and/or modified with any of the elements, components, regions, layers and/or sections disclosed herein to form one or more embodiments that may not be specifically illustrated or described herein.

The disclosures of all articles and references, including patent applications and publications, testing specifications, are incorporated by reference for all purposes. Other combinations are also possible as will be gleaned from the following claims, which are also hereby incorporated by reference into this written description.

1. A wheel for a vehicle that is reconfigurable between a pickup truck configuration and a sport utility vehicle (SUV) configuration, the vehicle comprising a vehicle frame configured to support both the pickup truck configuration and the SUV configuration and to allow reconfiguration therebetween without permanently modifying the vehicle frame, the wheel comprising:
a rim comprising an inner flange, an outer flange, and an intermediate region extending between and connecting the inner flange and the outer flange, the intermediate region comprising an inner surface and an opposing outer surface, the inner surface of the intermediate region comprises a disc support, and a tire is configured to surround the outer surface of the intermediate region;
a disc secured to the disc support of the rim and providing a wheel face that is dimensioned and configured to support a graphic design element, the disc comprising:
i. an outer wall having a proximal region secured to the disc support and a distal region extending outwardly from the disc support in a direction toward the outer flange;
ii. a generally planar wall extending from the distal region of the outer wall;
iii. a first inwardly angled wall extending inwardly from the generally planar wall towards a central rotational axis of the wheel;
iv. a second inwardly angled wall extending inwardly from the first inwardly angled wall towards the central rotational axis of the wheel and having a slope or angle that is less than a slope of the first inwardly angled wall relative to the central rotational axis of the wheel; and
v. a hub having a center opening that is surrounded by a plurality of lug openings;
wherein the wheel face comprises at least the generally planar wall.

2. The wheel according to claim 1, wherein the wheel face further comprises the first inwardly angled wall.

3. The wheel according to claim 1, wherein the generally planar wall extends at an angle relative to a plane that is perpendicular to the central rotational axis of the wheel by more than about 0 degrees and less than about 10 degrees, or by about 5 degrees.

4. The wheel according to claim 1, wherein the first inwardly angled wall extends at an angle relative to a plane that is perpendicular to the central rotational axis of the wheel by more than about 10 degrees and less than about 45 degrees, or about 20 degrees.

5. The wheel according to claim 4, wherein the second inwardly angled wall extends at an angle relative to a plane that is perpendicular to the central rotational axis of the wheel by more than about 30 degrees and less than about 70 degrees, or about 55 degrees.

6. The wheel according to claim 5, wherein the graphic design element comprises an outer perimeter that does not extend into the outer wall of the disc.

7. The wheel according to claim 6, wherein the graphic design element comprises an inner region that does not extend into or onto the second inwardly angled wall.

8. The wheel according to claim 7, wherein the wheel is free of mechanical fasteners for attaching the graphic design element to the wheel, and both of the rim and the disc are made of steel.

9. The wheel according to claim 8, wherein the graphic design element comprises a polymeric film or vinyl and an adhesive for attaching the graphic design element to the wheel face.

10. The wheel according to claim 9, wherein the graphic design element comprises one or more cutouts around the inner region through which at least part of the wheel face is visible.

11. The wheel according to claim 10, wherein the disc is free of any openings or cutouts in the wheel face, or the disc is free of any spokes in the wheel face.

12. The wheel according to claim 11, wherein the wheel face comprises one or more alignment features or poka-yoke features for aligning and orienting the graphic design element during installation onto the wheel face.

13. The wheel according to claim 12, further comprising a cover that is placed over the center opening of the hub.

14. The wheel according to claim 13, wherein the cover forms part of the wheel face further.

15. The wheel according to claim 14, wherein the rim, the disc, or both are made of steel.

16. A system comprising the wheel according to claim 15, in combination with a vehicle comprising a regenerative brake system.

17. A steel wheel for a vehicle, comprising:
a steel rim comprising an inner flange, an outer flange, and an intermediate region extending between and connecting the inner flange and the outer flange, the intermediate region comprising an outer surface and an opposing inner surface, wherein a tire surrounds the outer surface of the intermediate region, the inner surface of the intermediate region comprises a disc support;
a steel disc welded or secured to the disc support of the rim and providing a wheel face that is dimensioned and configured to support a graphic design element, wherein the graphic design element comprises a front face having a graphic design and a rear face comprising an adhesive,
wherein the disc comprises:
i. an outer wall having a proximal region secured to the disc support and a distal region extending outwardly from the disc support in a direction of outer flange;
iii. a first inwardly angled wall extending inwardly from the generally planar wall in a direction of a central rotational axis of the wheel;
iv. a second inwardly angled wall extending inwardly from the first inwardly angled wall in the direction of the central rotational axis of the wheel and having a slope or angle that is less than a slope of the first inwardly angled wall relative to the central rotational axis of the wheel; and
v. a hub having a center opening that is surrounded by a plurality of lug openings;
wherein the wheel face comprises the outer wall and the generally planar wall;
wherein the graphic design element is attached to the steel wheel by applying the adhesive side of the graphic design element onto the wheel face;
wherein the disc and wheel face are free of any openings or cutouts in the wheel face, or the disc is free of any spokes in the wheel face;
wherein the wheel is part of a vehicle that uses regenerative braking; and
wherein the steel wheel comprises one or more of the following elements selected from a list consisting essentially of:
i. the graphic design element comprises an outer perimeter that does not extend into the outer wall of the disc;
ii. the graphic design element comprises an inner region that does not extend into the second inwardly angled wall;
iii. the wheel is free of any mechanical fasteners for attaching the graphic design element to the wheel, and both of the rim and the disc are made of steel;
iv. the graphic design element comprises vinyl and an adhesive for attaching the graphic design element to the wheel face;
v. the graphic design element comprises one or more cutouts around the inner region through which at least part of the wheel face is visible; and
vi. the wheel face comprises one or more poka-yoke features for aligning and orienting the graphic design element during installation.

18. The wheel according to claim 17, wherein:
i. the generally planar wall extends at an angle from a vertical axis or plane that is perpendicular to a central rotational axis of the wheel by an angle more than about 0 degrees and less than about 10 degrees, preferably about 5 degrees;
ii. the first inwardly angled wall extends at an angle from a vertical axis or plane that is perpendicular to a central rotational axis of the wheel by an angle of more than about 10 degrees and less than about 45 degrees, preferably about 20 degrees; and/or
iii. the second inwardly wall extends at an angle from a vertical axis or plane that is perpendicular to a central rotational axis of the wheel by an angle of more than about 30 degrees and less than about 70 degrees, preferably about 55 degrees.

19. The steel wheel according to claim 18, wherein the graphic design element is configured to resist degradation, stone chip, peeling, for a period of at least 1 year, the graphic design element is configured to resist UV fading for at least a period of 2 years, and the graphic design element is configured to resist scratching for at least a period of 1 year .

20. A kit comprising the wheel according to claim 19, the graphic design element, a tool for applying the graphic design element, and a solution for cleaning the wheel before applying the graphic design element.
